(19) United States
(12) Patent Application Publication
(10) Pub. No.: US 2010/0030631 A1
(43) Pub. Date: Feb. 4, 2010

(54) Free Sample Provision Managing System and Its Program

(75) Inventor: Asuka Watanabe, Tokyo (JP)

Correspondence Address: Omori & Yaguchi USA, Eight Penn Center, Suite 1300, 1628 John F. Kennedy Blvd., Philadelphia, PA, 19103, US

(73) Assignee: c/o Luke 19 Co. Ltd, Shinjuku-ku Tokyo (JP)

(21) Appl. No.: 11/988,318

(22) PCT Filed: Jun. 20, 2006
(86) PCT No.: PCT/JP2006/312360

§ 371 Date: May 22, 2009

(30) Foreign Application Priority Data
Jul. 6, 2005 (JP) 2005 197914

(51) Int. Cl. G06Q 30/00

(52) U.S. Cl. 705/14.13; 705/14.19; 705/14.25; 705/14.33; 705/14.36

(57) ABSTRACT

The object of the present invention is to provide a system in which a use is capable of selecting a desired sample product over a network and receiving that selected sample product. A system is provided in which when distributing samples of products to a user via a network, displays distributable sample products on a user terminal that is used by the user, receives a selection for a sample product from the user terminal and manages the user that desires that sample product. This system comprises: a memory unit 12 for storing at least sample product information for a sample product to be distributed and user information of a user; a display unit 21 that displays sample product information to the user; a selection-receiving unit 22 that receives sample product selection information from the user; a point-calculation unit 20 that subtracts the number of sample product points that are included in the sample product information from the number of points that have been awarded to the user and included in the user information; and a sample-product-point-control unit 21 that controls the probability that the user will select the sample product by changing the number of points required for that sample product that is displayed to the user according to matching of the sample product information with attributes of the user.

### CROSS REFERENCE TO RELATED APPLICATIONS

This application claims priority under 35 U.S.C. 119 based upon Japanese Patent Application Serial No. 2005-197914, filed on Jul. 6, 2005. The entire disclosure of the aforesaid application is incorporated herein by reference.

### FIELD OF THE INVENTION

The present invention relates to a sample product offer management system that is operated over a network and applied to a portal website for distributing sample products.

### BACKGROUND OF THE INVENTION

Conventionally, in order to let consumers know of the advantages and superiority of their products, manufacturers have distributed free samples or comparatively inexpensive products. The methods used for distributing these sample products include displays or distribution by hand in shops and stores, street distribution, as well as recently, soliciting interest using the Internet and distributing the sample products by postal delivery or the like.

However, distribution methods used in stores or on the street comprise distribution and labor costs, and often it is difficult to specify to whom the sample products will actually be distributed, thus no effect is obtained other than a typical advertisement effect.

Moreover, in conventional methods that use the Internet, it is not possible to set effective application constraints, so even though an attempt is made to solicit a response from a limited target group, it is still necessary to rely on information from one's own assessment. In addition, since there is no incentive for applicants and those interested to limit themselves to only necessary applications, there is a problem in that there are many unnecessary applications, and thus it is not possible to obtain the desired effect from the distribution of sample products.

One known system for managing sample product offers is a system for collecting information related to sample product offers as disclosed in Japanese patent application No. 2002-99700. In that system, construction is such that information related to users and sample products is stored in the form of a database in a server; where users are able to use the same kind of sample product and accurate user information related to the sample product is obtained.

Moreover, a sample product distribution management method as disclosed in Japanese patent application No. 2004-326746 is a technique of managing and verifying member information while maintaining personal anonymity, in order to improve the targeting accuracy when performing services such as offering sample products to members.

Both of the techniques described above attempt to make it possible to manage users and more efficiently offer sample products, however, by managing user information, the techniques are such that only certain users are notified of information relating to sample products, so it is not possible for a user to freely select a sample product.

It is desired that sample products provide an advertising effect for consumers, so it cannot be said that a sufficient effect is obtained from distribution methods that are limited to certain users as in conventional management systems, and a server is not obtained that offers contents that can be enjoyed by many users.

### SUMMARY OF THE INVENTION

Taking into consideration the problems described above, it is the object of the present invention to provide a system in which a user can select and receive a desired sample product via the Internet.

Moreover, a more specific object of the present invention is to provide a sample product offer management system that is capable of controlling the selection probability for products to correspond with a user that selects a sample product.

In order to solve the problems described above, the present invention provides a sample product offer management system as described below.

A first aspect of the invention is a sample product offer management system that, when distributing samples of products to a user via a network, displays distributable sample products on a user terminal that is used by the user, receives a selection for a sample product from the user terminal and manages the user that desires that sample product, and comprises: a memory unit for storing at least sample product information for a sample product to be distributed and user information; a display unit that displays sample product information to a user; a selection-receiving unit that receives sample product selection information from a user; a point-calculation unit that subtracts the number of sample product points that are included in the sample product information from points that have been awarded to a user and included in the user information; and a sample-product-point-control unit that controls the probability that a user will select the sample product by changing the number of points required for that sample product that is displayed to the user according to matching of the sample product information with attributes of the user.

With this first aspect of the invention, the sample-product-point-control unit performs processing such that the number of sample product points that are displayed to a user is higher or lower than the original number of product sample points, and by displaying to user the number of sample product points that are the result of that processing, controls the probability that the user will select the sample product by making it easier or more difficult for the user to select the sample product.

With this kind of construction, points are awarded to a user, and the user can freely select sample products that are within the range of those points. In so doing, the user is able to have the enjoyment of selecting from a plurality of sample products, and by trying to effectively use the awarded points, the user selects only sample products in which the user has real interest.

As a result, it becomes possible for a provider, such as a manufacturer, that is offering the sample products, to distribute sample products to its patron base with a good advertisement effect.

Particularly, by changing the number of points required for a sample product based on information such as user attributes, it becomes possible to make it easier for users having the desired attributes for distribution to select a sample product, as well as it is possible for users of a different target group to obtain a sample product if really desired. The existence of such users leads to a provider discovering an unimaginable potential patron base, and contributes to more effective distribution of sample products.

Moreover, in another form of the present invention, the sample-product-point-control unit controls the selection probability by performing processing so that the number of sample product points displayed to a user becomes at least larger than the number of points belonging to the user, making it impossible for that user to select that sample product. Here, it is preferred that the sample-product-point-control unit perform processing so that the number of sample product points displayed to a certain user is greater than the number of points that the user having the most points has, and then control the selection probability in order that that user cannot select that sample product by displaying the number of sample product points resulting from that processing to the user.

With this kind of construction, it is possible to make it such that a user, whose attributes do not match a sample product having age restrictions, such as alcohol or the like, is unable to select the sample product.

Furthermore, in another form of the present invention, the system further comprises a user-information-management unit for having a user register and edit user information, where this user-information-management unit records the registration date and editing date of user information, and of that user information, makes it impossible to correct interest and preference information of a user for a specified period of time from the date that that interest and preference information was registered or edited. In this case, the user-information-management unit makes it impossible to edit the age and sex in the user information once that information has been registered.

With this kind of construction, it is possible to effectively prevent so-called ‘sample getters’ that frequently change their attributes in order to obtain various sample products.

In yet another form of the present invention, the system further comprises: a survey-display unit that, after a user selects a sample product, displays a survey related to that sample product to the user; and a survey-reply-monitoring unit that monitors replies to the survey, and when there is a reply, adds a specified number of points to that user's number of awarded points. Here, it is preferred that when there is no reply within a specified period of time, the survey-reply-monitoring unit decrease the user's number of awarded points.

With this kind of construction, it is possible to promote that the user reply to a survey that forms a set with the sample product, and this is effective in achieving the objective for distributing the sample product.

Moreover, a second main aspect of the present invention is a sample product offer management program that, when distributing samples of a product to a user via a network, is installed on a sever and displays distributable sample products on a user terminal that is used by a user, receives a selection for a sample product from the user terminal and manages the user that desires the sample product, and in order to operate a storage medium and the server that houses that storage medium causes the server to function as: a memory unit that stores at least sample product information for sample products to be distributed and user information of users; a display unit that displays sample production information to a user; a selection-receiving unit that receives sample product selection information from a user; a point-calculation unit that subtracts the number of sample product points that are included in the sample product information from points that have been awarded to a user and included in the user information; and a sample-product-point-control unit that controls the selection probability that a user will select the sample product by changing the number of points required for that sample product that is displayed to the user according to matching of the sample product information with attributes of the user.

With this kind of construction, by installing this program onto a server, it is possible to create the sample product offer management system of the first main aspect of the present invention.

Other features and significant effects of the present invention that are not listed here will become apparent to one in the field by referencing the explanation of the embodiments of the invention given below together with the supplied drawings.

### BRIEF DESCRIPTION OF THE DRAWINGS

FIG. 1 is a drawing of the overall sample product offer management system of the present invention.

FIG. 2 is a drawing of the construction of a management server of the present invention.

FIG. 3 is a drawing of the construction of a user terminal of the present invention.

FIG. 4 is a flowchart of the sample product offering process of the present invention.

FIG. 5 is a flowchart of the sample product selection receiving process of the present invention.

FIG. 6 is a flowchart of the process of the present invention for checking the number of points awarded to a user.

FIG. 7 is a flowchart of the process of the present invention for displaying product information.

### DETAILED DESCRIPTION OF THE INVENTION

In the following, preferred embodiments of the present invention will be described in detail with reference to the accompanying diagrams. The present invention is not limited to the embodiments described below.

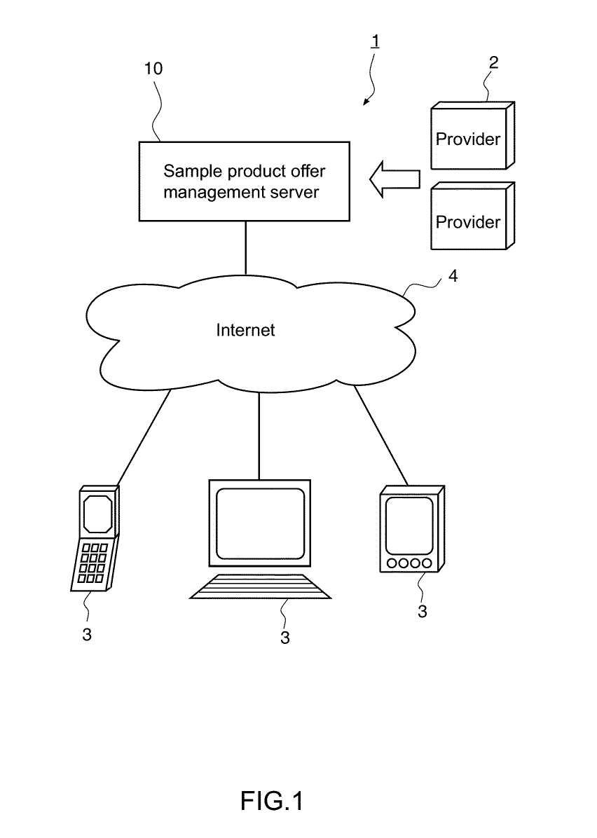

FIG. 1 is a drawing showing the overall sample product offer management system 1 of the present invention. As shown in the figure, a provider 2 of sample products registers information about sample products to be distributed on a sample product offer management server (hereafter, referred to as a management server) 10. The management server 10 is located on the Internet 4.

As is well known, a plurality of user terminals 3 that are connected via the Internet can bed connected to the management server (10). Any kind of user terminal can be used, for example, mobile telephones, personal computers, mobile information terminals (PDA) and the like are typically used.

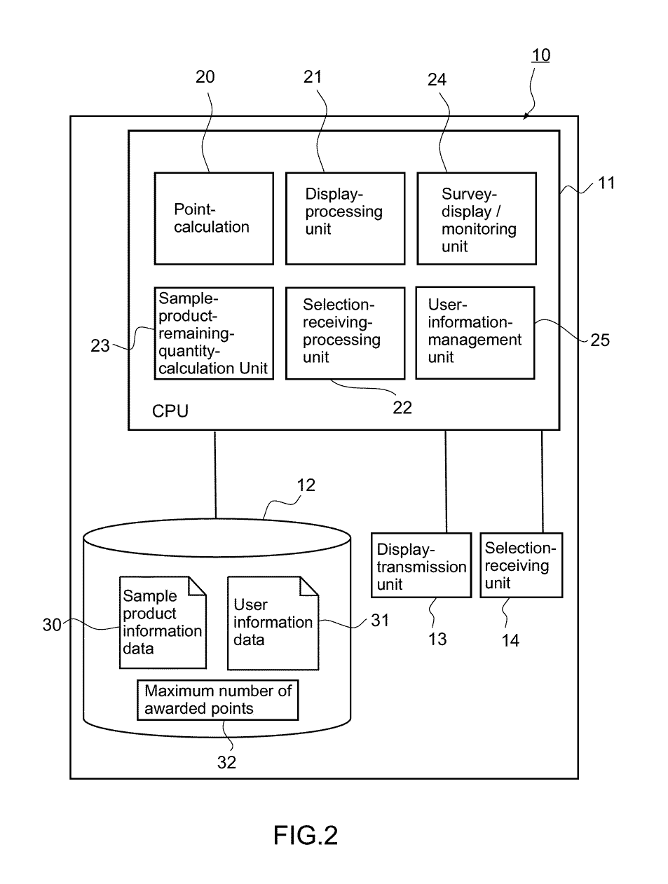

FIG. 2 is a drawing of the construction of the management server 10. The management server 10 can be constructed from a known computer system, and this management server comprises: a CPU (not shown in the figure), an external memory device such as a hard disk, memory (not shown in the figure), output unit such as a monitor, and an input unit such as a keyboard. Furthermore, by attaching a network adapter, the management server 10 can be connected to the Internet.

FIG. 2 is a function diagram showing the construction of this management server 10.

This management server 10 mainly comprises: a sample-product-offer-processing unit 11 that performs the necessary processing for offering sample products; an information-memory unit 12 that stores information about the sample products to be offered and users; a display-transmission unit 13 for displaying sample products; and a selection-receiving unit 14 that receives a selection for a sample product.

These components 11 to 14 are actually a fixed area that is maintained on a memory medium such as a hard disk or a computer software program that is stored on that memory medium, where the components shown in FIG. 2 are formed by the CPU calling up and executing that program.

Each of the components 11 to 14 will be explained below.

First, the memory unit 12 stores sample product information data 30 and user information data 31. The product sample information data 30 is data that is registered by the provider of a sample product and comprises at least the name of the sample product, the number of points necessary when a user selects the sample product, conditions for target users (processing algorithm), and conditions for non-target users (processing algorithm). In addition, when the number of sample products is limited, the product sample information data 30 also includes the total number (remaining number) of sample products.

User information about a user using a user terminal and that is necessary for the user to use the management server 10 is registered in the user information 31. A user that is accessing the server is identified by a verification process that is performed first when accessing the server, or by a web browser ID method (for example a method using cookies). Of these methods, there are many various kinds of methods that are used by websites on the Internet, and any of those methods can be used.

The user information 31 includes an ID or password, as well as invariant information such as age and sex, and variable information such as preference and interest information, the number of points that have been awarded to a user, and the like. Moreover, the memory unit 12 stores the number of points of the user that has the most number of points among all the users as maximum point information.

In addition to comprising this kind of information data 30, 31, 32, the sample-product-offer-processing unit 11 of the server 10 of the present invention makes it possible to view sample product information data 30 on the Internet via the display-transmission unit 13.

This sample-product-offer-processing unit 11 comprises: a display-processing unit 21 (the sample-product-point-control unit of the invention) that controls the probability of sample product selection of a user by changing sample product information that is displayed according to the user attributes, particularly changing the sample product points; a selection-receiving unit 22 that receives the sample product selection from a user; a point-calculation unit 20 that together with calculating the number of points after selection, calculates incentives; a sample-product-remaining-quantity-calculation unit 23 that calculates the number of sample products remaining and updates the sample product information; a survey-display/monitoring unit 24 that displays a survey and manages the replies to that survey; and a user-information-management unit 25 that manages registration and updates of user information.

The construction and function of these components will be explained in detail below by explaining actual processing.

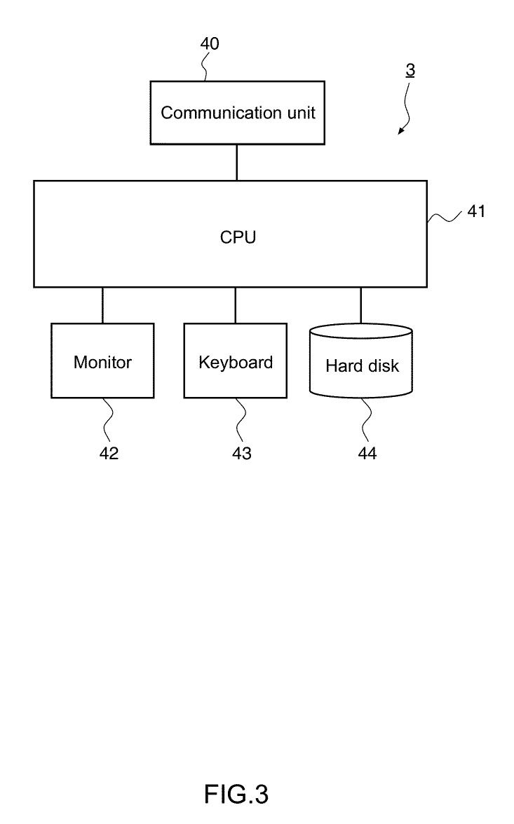

First, before that explanation, the user terminal will briefly be explained. FIG. 3 shows the typical construction of a user terminal, where a network adapter, which is a communication unit 40 for connecting to a network such as the Internet, is connected to a CPU 41. In addition, through display processing by the CPU 41, the received sample product information data is displayed to the user on a monitor 42.

The user uses an input unit such as a keyboard 43, mouse or the like to select a desired sample product. The selection information is sent from the CPU 41 to the server 10 via the communication unit 40.

In the case of a typical personal computer, the terminal comprises a hard disk 44 or the like, and stores application software such as a web browser and information such as cookies.

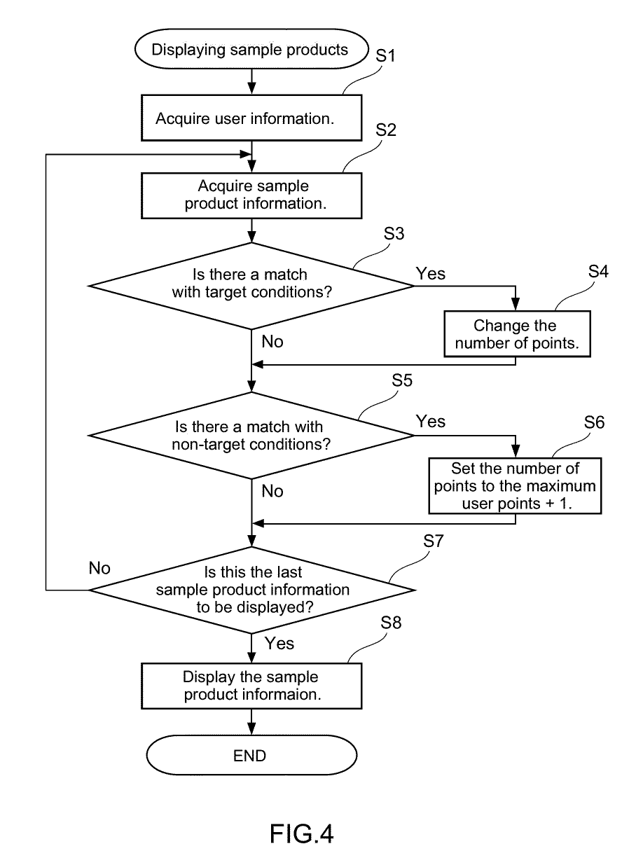

First, FIG. 4 is a flowchart showing the operation when a user displays sample product information on the screen of the terminal.

In other words, when a user searches for sample products on a site, and sample product information is displayed, the display-processing unit 21 executes the steps S1 to S8 of this process.

First, user information 31 is acquired based on the accessing user ID (step S1). Next, the first sample product information 32 to be displayed is extracted from the memory unit (step S2), then the target conditions and non-target conditions for this sample product information are matched with the user information 31 (invariant information and variable information) (steps S3, S5), and the sample product points to be displayed to the user as sample product information are set (steps S4, S6).

For example, in the case where the conditions “30 to 40 year old female, married” are set as target conditions and the user information does not fit in this range (step S3, NO), the number of sample product points that were originally included in the sample product information 30 as the sample product points are displayed, however when the user information fits the target conditions (step S3, YES), the sample product points are decreased and displayed. It is preferred that the specified amount for decreasing the sample product points be included in the target conditions, however, the amount to decrease the points (for example 10%) can also be set according to the required number of sample product points.

Moreover, in the case where an age of under 20, as in the case of alcohol, is set as a non-target condition, the display-processing unit 11 extracts the maximum point information 32 from the memory unit as the sample product points, and by displaying the maximum points+1 as the required number of sample products points for the sample product (step S6), it becomes essentially impossible for the user to select the sample product. It is also possible to manually set the sample product points that are displayed to the user, and in this case, the sample product points could be set as 9999999.

Next, it is determined whether the sample product is the last sample product to be displayed, and when it is not the last, steps S2 to S7 are repeatedly executed until the last sample product to be displayed. After processing is complete for all of the sample products, the sample product information is collected together and displayed on the user terminal (step S8).

Sample products are displayed to the user for selection in this way, however, when doing this, the user information and sample product information are matched, and as a result of the matching, the required number of sample product points are changed. By doing this, the selection probability of the sample products by the user is dynamically changed, and control can be performed to make it easy for a user to whom the provider wants to distribute the sample product to select the sample product, and to make it difficult for a user to whom the provider does not want to distribute the sample product to select the sample product. In addition, with this method of controlling a user's selection by changing the sample product points in this way, computer processing becomes easier and faster than with other methods (methods in which there is no display or other control is performed with other information).

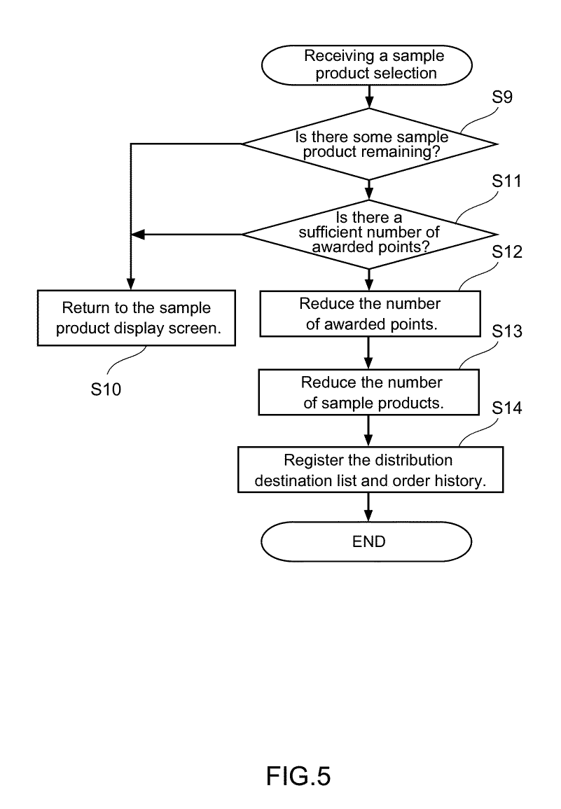

Next, the processing after selection of the sample product will be explained with reference to FIG. 5.

As was described above, sample product information is displayed to the user together with the required number of sample product points, and when the user selects a sample product, processing is performed as shown in steps S9 to S13.

First, the sample product information data 30 is referenced to determine whether or not there are restrictions on the number of sample products, and when there are restrictions, whether there are any of the sample product remaining is checked (step S9).

When there is no more of the sample product remaining, the user is notified of that (returns to the sample product display screen: step S10), however when there is some of the sample product remaining, whether or not the user has enough points for requesting a sample product is checked by obtaining the required number of sample product points from the sample product information data 30 and comparing it with the user information data 31 (step S11).

When the user does not have the required number of points, the user is notified as described above (returns to the sample product display screen: step S10), however, when the user has enough points, the point-calculation unit 20 performs processing to subtract the number of points for the sample product from the current number of points the user has (step S12).

Furthermore, when the remaining quantity of sample product is set, the sample-product-remaining-quantity-calculation unit 23 subtracts the number of the sample product requested by the user from the remaining quantity in the sample product information data 30 (step S13).

In the present invention, the result of the user's order of the sample product that is acquired as described above can be used in any way, however the simplest way is to register the information about the user desiring the sample product on a hard disk as distribution destination list data (step S14), and use that data when actually sending the product. The order request for the sample product is stored by the aforementioned user-information-management unit 25 together with the date of the order as order history information.

Since a user uses his/her own points in this way to order a sample product, it also becomes possible for the provider to more efficiently distribute sample products without there being excessive orders. In addition, from the aspect that it is possible for the user to select desired sample products from among many available sample products by simply using points, the selection choices increase more than in the method of distribution to only specified target users, and thus it is possible to provide contents that are fun to select from.

Moreover, in this embodiment, construction is such that by performing a process of adding points (adding incentive), it possible for a user to repeatedly order sample products. This process of adding points is performed by the point-calculation unit 20.

This process of adding points can be such that 100 points are added each time a user accesses the service, or the amount of points added could change according to results of a game during access. When doing this, by limiting the awarding of points to a maximum of one time per day, it is possible to provide the user with an incentive to access the service every day.

Moreover, in this embodiment, it is also possible for the survey-display/monitoring unit 24 to add or subtract points.

The survey-display/monitoring unit 24 requests that a user to which a sample product has already been distributed reply to a survey during access, and by way of the display-processing unit 21 sends a survey form that is stored beforehand on the hard disk 12 to the user terminal. After the reply to the survey is sent by the user and received by the selection-receiving unit 14, that reply is confirmed by the survey-display/monitoring unit 24, and after being correlated with the sample product, the survey is registered in survey reply history information in the user information 31.

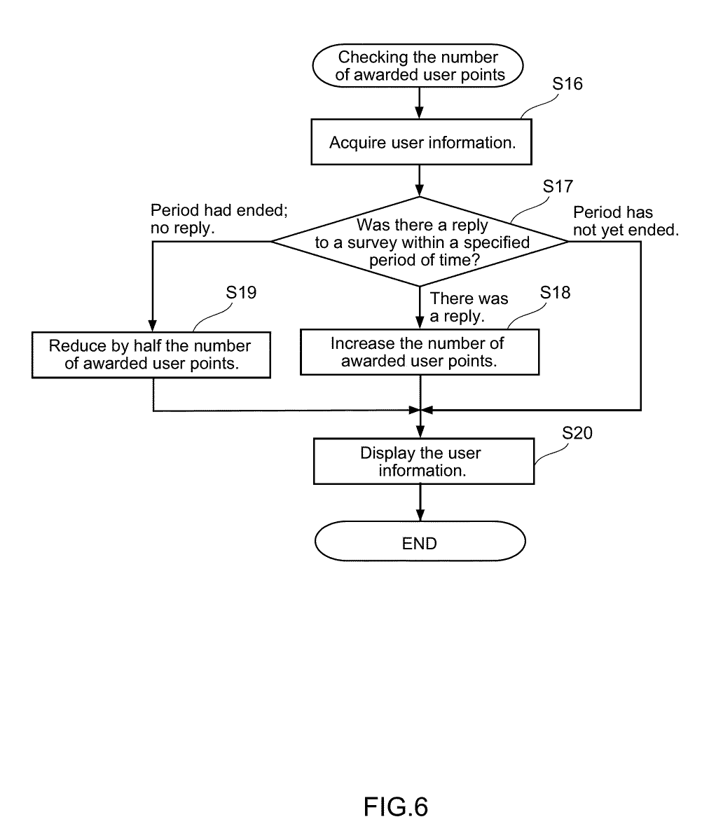

FIG. 6 is a flowchart showing the operation when reflecting the reply to the survey in the user points when checking the user points (steps S1, S11).

First, the user information that contains the sample product order history information and the survey reply history information is acquired from the memory unit 12 (step S16). Next, by matching this history information, it is determined whether the user replied to a survey within the specified period of time (step S17), when the reply was within the specified period of time (step S17: “Replied”), the points awarded to the user are increased as an incentive bonus (step 18). On the other hand, when there wasn't a reply to the survey within the specified period of time (for example, 15 days) (step S17: “Period ended with NO reply”, the user's points are decreased by half as an incentive to reply to the survey (step S19). The awarded points that have been changed in this way are updated in the user information as new points (step S20). Moreover, when the survey period has not yet ended (step S17: “Period has not ended”), the number of points acquired from the user information in step S16 is displayed as is.

The amount that the number of points is increased can be a set amount of points, can be set individually for each sample product, or can be a fixed percentage.

By doing this, incentives or penalties are given for replying to surveys, so it is possible to promote replying to a survey. This makes it possible to more accurately measure the effect of distributing sample products.

Moreover, as another incentive, it is also possible to add points to a user to which a sample product has not been distributed in response to the user's cooperation in replying to a survey, and by doing this, it is possible for that user to use the points obtained in the user's next order of a sample product.

The management server 10 of this embodiment may also have a function for selling products together with offering sample products.

More specifically, together with displaying sample products, the display-processing unit 21 also displays information about the product when the remaining quantity of the sample product is 0. The product information that is displayed includes the name and price of the product, as well as a photo or the like of the product. At the same time, a barcode that is readable by a mobile telephone or the like can be displayed, and by reading that barcode by a device other than the user terminal, purchasing procedures can be performed.

When the user terminal is used to perform a purchase selection instead of a selection for a sample product, the selection-receiving unit 22 performs the process for receiving the purchase. The purchasing process itself has the same construction as that performed by a known product sales server, so an explanation of it will be omitted here.

This form of the embodiment has a mechanism that, after receiving a purchase order, changes the price in correlation with the remaining quantity of the sample product.

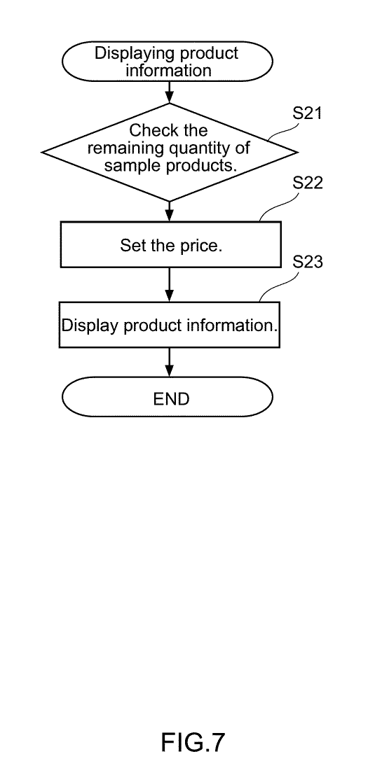

In other words, as shown in FIG. 7, the display-processing unit 21 acquires the remaining quantity of sample product from the sample-product-remaining-quantity-calculation unit 23 (step S21), and sets the price according to the correspondence between the remaining quantity of the sample product and the sales price that is stored in the product information data (not shown in the figure) on the hard disk (step S22). For example, when the remaining quantity of the sample product is a value other than 0, the price is displayed as 3,000 yen, however, when the remaining quantity becomes 0, the price is displayed as 2,100 yen (step S23).

The price can be set in advance, or construction can be such that a discount rate is defined, and that discount rate changes according to the remaining quantity of the sample product.

By doing this, even when the remaining quantity becomes 0 and it is not possible to obtain the sample product, by offering the product at a moderate price, it is possible to collect the interest of users for that product. In addition, even when there is some of the sample product remaining, it is possible to receive purchase requests from users that want the product using the same system, which is convenient for both the provider side and user side.

Finally, the operation of the user-information-management unit 25 will be explained.

This user-information-management unit 25 controls new registration of information and changes to the registered information. That is, this user-information-management unit 25 records the registration date and editing date of the user information 31, and of the user information, makes it impossible to make corrections to interest and preference information during a specified period of time (three months in this embodiment) after the information is registered or edited. Moreover, of the user information 31, this user-information-management unit 25 makes it impossible to edit the age and sex information after once being registered.

With this kind of construction, it is possible to effectively prevent so-called ‘Sample Getters’ who frequently change their attributes in order to get various sample products, and together with maintaining fairness among users, it is possible to ensure the effect of distributing sample products.

This present invention is not limited to the embodiments described above, and various forms are possible within a range that does not change the scope of the invention.

For example, in the embodiment described above, changing the number of sample product points was performed by setting the number of sample product points in the sample product information data 30 in accordance to the attribute information, for example age, sex, address and the like, of the user that selected the sample product, however, when doing this various methods could be employed.

For example, it is possible to set the required number of sample product points beforehand in two categories, such as 100 points for men in their 40s, and 500 points for all other users. Not only is it possible to set two kinds of sample product points, it is possible to set the number of points in more steps, such as 500 points for users who are in their teens or younger, and gradually decrease the number of points by 50 points for every 10-year age group beginning with those in their 20s, so that 250 points are set for those over 60 years old. In addition, it is also possible to set points according to region, for example, 200 points for users in the Tohoku area, and 500 points for users in all other areas.

By doing this, it is possible for the provider to perform distribution to users to whom they want to offer sample products according to useful conditions. Moreover, it is also possible to allow users, even though they are not target users, to order sample products according to their individual preferences. This kind of order information also has merits for the provider side in that it allows the provider to know and obtain valuable information about potential customers.

In the present invention, not only is it possible to correlate the change in the number of points according to user attributes that are defined as described above, but also according to any other information that is stored in the user information.

For example, using the point information, a relatively low number of sample product points or a high number of sample product points are applied to a user having a large number of points remaining. Moreover, when points are awarded when a user performs a set service for a sample product provider (manufacturer, etc.) such as replying to a survey or introducing other users, it is possible to lower the sample product points in order to reward that kind of user.

Furthermore, in the embodiments described above, the survey history information for replying to surveys was saved, and the number of points awarded to a user was updated when checking the user information, however, it is also possible to update the number of points awarded in real-time at the instant a reply to a survey is received, or when the period for replying to a survey has ended.

What is claimed is:

1. A sample product offer management system for distributing samples of products to a user via a network, which displays distributable sample products on a terminal that is used by a user, receives a selection of a sample product from the user's terminal, and manages the user who desires the sample product, comprising:
a memory unit for storing at least sample product information concerning a sample product to be distributed and user information concerning a user;
a display unit for displaying sample product information to the user;
a selection-receiving unit that receives sample product selection information from the user;
a point-calculation unit for subtracting a number of sample product points that is included in the sample product information from a number of points that has been awarded to the user and included in the user information; and
a sample-product-point-control unit for controlling a probability that the user will select the sample product by changing and displaying to the user the number of points required for the sample product according to matching of the sample product information with attributes of the user.

2. The sample product offer management system of claim 1 wherein
said sample-product-point-control unit controls the probability of the user selecting the sample product, by processing such that a number of sample product points to be displayed to the user is higher than an original number of sample product points, and displaying to the user the number of sample product points resulting from the processing, thereby making it more difficult for the user to select the sample product.

3. The sample product offer management system of claim 1, wherein
said sample-product-point-control unit controls said probability of the user selecting the sample product by performing a processing such that the number of sample product points to be displayed to the user becomes at least larger than the number of points belonging to the user, making it impossible for the user to select the sample product.

4. The sample product offer management system of claim 3, wherein
said sample-product-point-control unit performs processing so that the number of sample product points to be displayed to the user is greater than the largest number of points that is possessed by any of all users in the user information, and displays the number of sample product points resulting from the processing, thereby controlling said probability of user by making it impossible for the user to select the sample product.

5. The sample product offer management system of claim 1, further comprising a user-information-management unit for having a user register and edit user information, wherein
said user-information-management unit records the registration date and editing date of user information, and for that user information, makes it impossible to correct interest and preference information of the user for a specified period of time from the date that that interest and preference information was registered or edited.

6. The sample product offer management system of claim 5, wherein
said user-information-management unit makes it impossible to edit the age and sex in the user information once that information has been registered.

7. The sample product offer management system of claim 1, further comprising:
a survey-display unit that, after said user selects a sample product, displays a survey related to that sample product to the user; and
a survey-reply-monitoring unit that monitors replies to said survey, and when there is a reply, adds a specified number of points to that user's number of awarded points.

8. The sample product offer management system of claim 7, wherein
said survey-reply-monitoring unit decreases the user's number of awarded points when there is no reply within a specified period of time.

9. A sample product offer management program, stored in a computer readable storage medium, which is installed on a server on the Internet for distributing samples of a product to a user via a network, which displays distributable sample products on a user terminal that is used by a user, receives a selection of a sample product from the user terminal and manages the user that desires the sample product,
said sample product offer management program comprising:
a memory unit for causing the server to store at least sample product information concerning a sample product to be distributed and user information concerning a user;
a display unit for causing the server to display sample product information to said user;
a selection-receiving unit for causing the server to receive sample product selection information from said user;
a point-calculation unit for causing the server to subtract a number of sample product points that are included in the sample product information from a number of points that have been awarded to said user and included in the user information; and
a sample-product-point-control unit for causing the server to control the probability that said user will select the sample product by changing and displaying to the user the number of points required for the sample product according to matching of the sample product information with attributes of the user.

10. The sample product offer management program of claim 9, wherein
said sample-product-point-control unit controls the probability of the user selecting the sample product, by processing such that a number of sample product points to be displayed to the user is higher than an original number of sample product points, and displaying to the user the number of sample product points resulting from the processing, thereby making it more difficult for the user to select the sample product.

11. The sample product offer management program of claim 9, wherein
said sample-product-point-control unit controls said probability of the user selecting the sample product by performing a processing such that the number of sample product points to be displayed to the user becomes at least larger than the number of points belonging to the user, making it impossible for the user to select the sample product.

12. The sample product offer management program of claim 10, wherein
said sample-product-point-control unit performs processing so that the number of sample product points to be displayed to the user is greater than the largest number of points that is possessed by any of all users in the user information, and displays the number of sample product points resulting from the processing, thereby controlling said probability of user by making it impossible for the user to select the sample product.

13. The sample product offer management program of claim 9, further comprising a user-information-management unit for having a user register and edit user information, wherein
said user-information-management unit records the registration date and editing date of user information, and for that user information, makes it impossible to correct interest and preference information of the user for a specified period of time from the date that that interest and preference information was registered or edited.

14. The sample product offer management program of claim 13, wherein
said user-information-management unit makes it impossible to edit the age and sex in the user information once that information has been registered.

15. The sample product offer management program of claim 9, further comprising:
a survey-display unit that, after said user selects a sample product, displays a survey related to that sample product to the user; and
a survey-reply-monitoring unit that monitors replies to said survey, and when there is a reply, adds a specified number of points to that user's number of awarded points.

16. The sample product offer management program of claim 15, wherein
said survey-reply-monitoring unit decreases the user's number of awarded points when there is no reply within a specified period of time.
